(19) United States
(12) Patent Application Publication
(10) Pub. No.: US 2006/0198097 A1
(43) Pub. Date: Sep. 7, 2006

(54) Video signal processing apparatus

(75) Inventors: Naoki Kuwajima, Fukaya-shi (JP); Takayoshi Mogi, Fukaya-shi (JP); Hiroshi Azami, Chichibu-shi (JP); Takashi Asano, Fukaya-shi (JP); Shota Kida, Fukaya-shi (JP); Kazuyuki Rikiishi, Fukaya-shi (JP); Masakazu Nakamura, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/357,190

(22) Filed: Feb. 21, 2006

(30) Foreign Application Priority Data
Mar. 4, 2005 (JP) 2005-061438

(51) Int. Cl. G06F 1/16

(52) U.S. Cl. 361/685

(57) ABSTRACT

According to one embodiment, there is provided a video signal processing apparatus including an apparatus main body which performs predetermined signal processing to a received video signal to display the video signal, an HDD unit which incorporates an HDD therein, and a stand which is placed on a predetermined base and supports the apparatus main body so as to upright stand a video display screen, the stand having a storing unit which attachably/detachably stores the HDD unit in the stand.

### CROSS-REFERENCE TO RELATED APPLICATIONS

This application is based upon and claims the benefit of priority from prior Japanese Patent Application No. 2005-061438, filed Mar. 4, 2005, the entire contents of which are incorporated herein by reference.

### BACKGROUND

1. Field

One embodiment of the invention relates to a video signal processing apparatus such as a digital television broadcasting receiver.

2. Description of the Related Art

As is well known, in recent years, digitization of television broadcasting is moved ahead. For example, in Japan, not only satellite digital broadcasting such as BS (broadcasting satellite) digital broadcasting and 110° CS (communication satellite) digital broadcasting, but also digital terrestrial broadcasting are started.

Some television broadcasting receiver which receives television broadcasting has the following function. That is, for example, broadcasting programs are automatically recorded on the basis of a category or a keyword set by a user, and the user can select a necessary program from the recorded broadcasting programs to watch the program.

In this case, a recording and reproducing apparatus to record and reproduce a broadcasting program requires a large recording capacity and access capability of rapidly retrieving and reproducing a desired program from the recorded programs. For this reason, a hard disk drive (HDD) is employed.

As a current television broadcasting receiver, a thin and large-screen television which employs a flat panel display constituted by a liquid-crystal display or a plasma display as a video display unit tends to be popularized. In this case, a measure for efficiently installing an HDD in a television broadcasting receiver without spoiling the thinness of the receiver is important.

In this case, any one of Jpn. Pat. Appln. KOKAI Publication Nos. 2000-357026 and 2001-5558 discloses a configuration in which a hard disk drive is stored in a base portion put on a predetermined placing face in an apparatus main body for supporting the liquid crystal display unit in a desk-top personal computer.

Jpn. Pat. Appln. KOKAI Publication No. 2002-14745 discloses a configuration in which, in a personal computer having a liquid crystal display unit on a major surface of a housing, a liquid crystal display unit is openably and closeably installed in the housing to make it possible to mount an HDD in an HDD bay arranged in the housing by the liquid crystal display unit opened by a user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an embodiment of the invention, and is an external view for explaining a television broadcasting receiver;

FIG. 2 is a block diagram shown to explain a signal processing system of a television broadcasting receiver according to the embodiment;

FIG. 3 is a perspective view showing a stand of the television broadcasting receiver according to the embodiment to explain a state obtained when viewing the stand from the back side;

FIG. 4 is an external view shown to explain an HDD unit to be stored in the television broadcasting receiver according to the embodiment;

FIG. 5 is a perspective view showing the stand of the television broadcasting receiver according to the embodiment to explain a state obtained when viewing the stand from the back side;

FIG. 6 is an exploded perspective view shown to explain an internal configuration of the HDD unit to be stored in the television broadcasting receiver according to the embodiment;

FIG. 7 is a perspective view shown to explain the internal configuration of the HDD unit to be stored in the television broadcasting receiver according to the embodiment;

FIG. 8 is a perspective view shown to explain a state in which the HDD unit is stored in the stand of the television broadcasting receiver according to the embodiment;

FIG. 9 is a perspective view shown to explain an internal configuration of the stand of the television broadcasting receiver according to the embodiment;

FIG. 10 is a plan view shown to explain a state in which the HDD unit is stored in the stand of the television broadcasting receiver according to the embodiment;

FIG. 11 is a plan view shown to explain a state in which the HDD unit is stored in the stand of the television broadcasting receiver according to the embodiment; and

FIG. 12 is a block diagram shown to explain a signal processing system of the television broadcasting receiver according to the embodiment.

### DETAILED DESCRIPTION

Various embodiments according to the invention will be described hereinafter with reference to the accompanying drawings. In general, according to one embodiment of the invention, there is provided a video signal processing apparatus including an apparatus main body which performs predetermined signal processing to a received video signal to display the video signal, an HDD unit which incorporates an HDD therein, and a stand which is placed on a predetermined base and supports the apparatus main body so as to upright stand a video display screen, the stand having a storing unit which attachably/detachably stores the HDD unit in the stand.

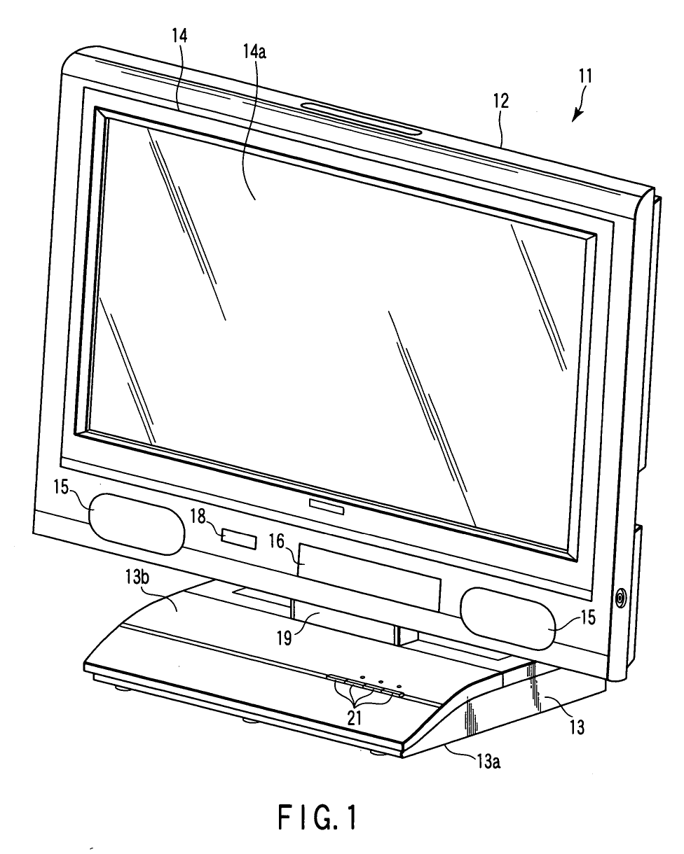

FIG. 1 shows a front appearance of a television broadcasting receiver 11 to be explained in the embodiment. More specifically, the television broadcasting receiver 11 is mainly constituted by a thin cabinet 12 serving as a receiver main body and formed in an almost square shape and a stand 13 which upright stands and supports the cabinet 12.

On the cabinet 12, a display screen 14a of the video display unit 14 constituted by, for example, a flat liquid crystal display panel is exposed on the front face. In addition, a pair of loudspeakers 15, operation unit 16, a light-receiving unit 18 to receive operation information transmitted from a remote controller 17 (not shown in FIG. 1) (will be described later), and the like are arranged on the cabinet 12.

The stand 13 is formed in an almost thin-box-like shape. A bottom plate 13a serving as one plane of the stand 13 is placed on a predetermined base (not shown) which is horizontally set. The stand 13 supports the cabinet 12 stood such that a support member 19 upwardly projecting from an almost central portion of an upper plate 13b serving as a plane opposing the plane placed on the base is connected to the back face of the cabinet 12.

In this case, the stand 13 is configured to store an HDD unit (not shown in FIG. 1) 20 (will be described later). On the upper plate 13b of the stand 13, a plurality of operators 21 (four operators are shown in FIG. 1) which can be operated by pressure to control a recording state, a reproducing state, a stop state, and the like are arranged at a portion extending to the front side with reference to the cabinet 12.

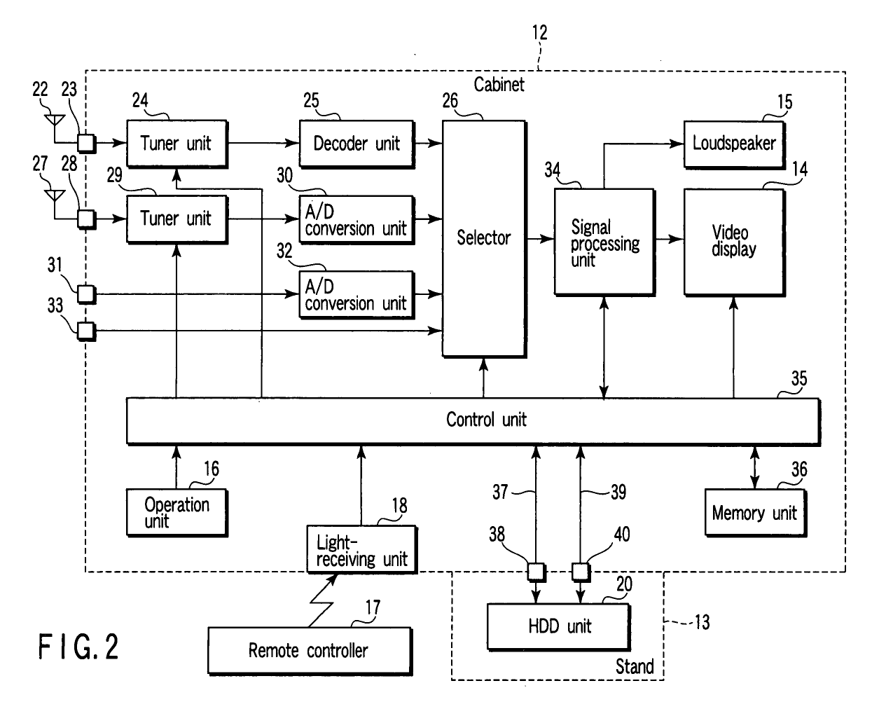

FIG. 2 schematically shows a signal processing system of the television broadcasting receiver 11. Various circuit blocks constituting the signal processing system are arranged at a position near the back face of the cabinet 12 in the cabinet 12, i.e., near the rear side of the display screen 14a of the video display unit 14.

A digital television broadcasting signal received by an antenna 22 for receiving digital television broadcasting is supplied to a tuner unit 24 through an input terminal 23. The tuner unit 24 selects a signal of a desired channel from input digital television broadcasting signals to demodulate the signal. A signal output from the tuner unit 24 is supplied to a decoder unit 25 and subjected to MPEG (moving picture experts group) 2 decode processing. The resultant signal is supplied to a selector 26.

Furthermore, the analog television broadcasting signal received by an antenna 27 for receiving analog television broadcasting is supplied to a tuner unit 29 through an input terminal 28. The tuner unit 29 selects a signal of a desired channel from input analog television broadcasting signals to demodulate the signal. A signal output from the tuner unit 29 is digitized by an analog/digital (A/D) conversion unit 30 and then output to the selector 26.

Analog video and audio signals supplied to an input terminal 31 for an analog signal are supplied to an A/D conversion unit 32, digitized, and output to the selector 26. Furthermore, the digital video and audio signals supplied to an input terminal 33 for a digital signal are directly supplied to the selector 26.

The selector 26 selects one from input digital video and audio signals of four types to supply the selected signal to a signal processing unit 34. The signal processing unit 34 performs predetermined signal processing to the input digital video signal to serve to display a video image on the video display unit 14. As the video display unit 14, for example, a flat panel display constituted by a liquid crystal display, a plasma display, or the like is employed. The signal processing unit 34 performs predetermined signal processing to the input digital audio signal to make the digital signal into an analog signal, and the analog signal is output to the loudspeakers 15 to reproduce voice.

In the television broadcasting receiver 11, various operations including the above various receiving operations are generally controlled by a control unit 35. The control unit 35 is a microprocessor in which a central processing unit (CPU) or the like is built. The control unit 35 receives operation information from the operation unit 16 or the operator 21 (not shown in FIG. 2) or operation information transmitted from the remote controller 17 through the light-receiving unit 18 to control the respective units such that the operation contents are reflected.

In this case, the control unit 35 uses a memory unit 36. The memory unit 36 mainly includes a read only memory (ROM) in which a control program executed by the CPU is stored, a random access memory (RAM) to provide a work area for the CPU, and a nonvolatile memory in which various pieces of setting information, various pieces of control information, and the like are stored.

The control unit 35 is connected to the HDD unit 20 stored in the stand 13. In this case, a line 37 which supplies an electric source power and a control signal from the control unit 35 to the HDD unit 20 connects the selector 26 and the HDD unit 20 through a connection unit 38.

A line 39 which exchanges digital video and audio signals with the control unit 35 and the HDD unit 20 connects the control unit 35 and the HDD unit 20 through an i.Link connection unit 40. More specifically, transmission of the digital video and audio signals between the control unit 35 and the HDD unit 20 is performed by i.Link independently of the power supply and the control signal.

The television broadcasting receiver 11 records the digital video and audio signals selected by the selector 26 by the HDD unit 20, and the digital video and audio signals recorded on the HDD unit 20 are reproduced to serve to watch a program.

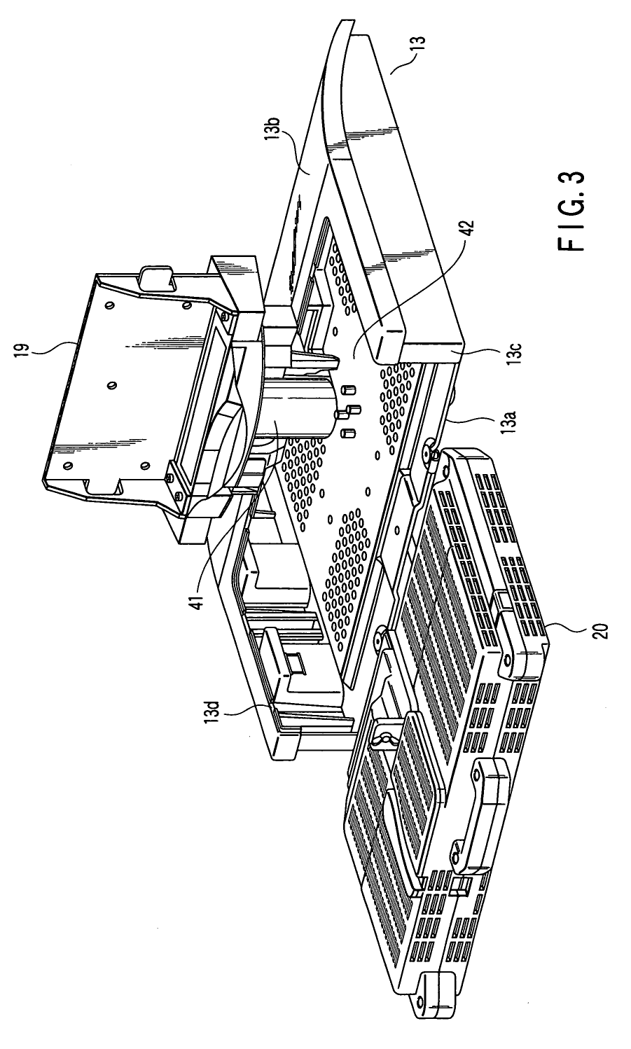

FIG. 3 shows the stand 13 when viewed from the back side. More specifically, the stand 13 is formed in an almost thin-box-like shape as described above. A most part of the stand 13 is continuously opened from a back plate 13c to an almost central portion of the upper plate 13b to form an attaching/detaching port 13d. The attaching/detaching port 13d can be opened or closed by a lid (not shown).

At an almost center portion of the bottom plate 13a of the stand 13, a cylindrical support columnar member 41 is perpendicularly protruded. The distal end of the support columnar member 41 projects above the upper plate 13b through the attaching/detaching port 13d formed in the upper plate 13b. The support member 19 to be connected to the cabinet 12 is attached to the distal end of the support columnar member 41.

A most part in the stand 13 is hollow to be a storing unit 42 which can store the HDD unit 20 therein. In this case, the HDD unit 20 is inserted from the outside of the stand 13 along the bottom plate 13a from the attaching/detaching port 13d on the back side of the stand 13, and the HDD unit 20 is stored in the stand 13. The HDD unit 20 stored in the stand 13 can be extracted to the outside of the stand 13 along the bottom plate 13a from the attaching/detaching port 13d on the back side of the stand 13.

More specifically, the HDD unit 20 is stored in the stand 13 and can record and reproduce video and audio signals. In addition, the HDD unit 20 is configured to be attached to or detached from the stand 13, i.e., to be exchangeable.

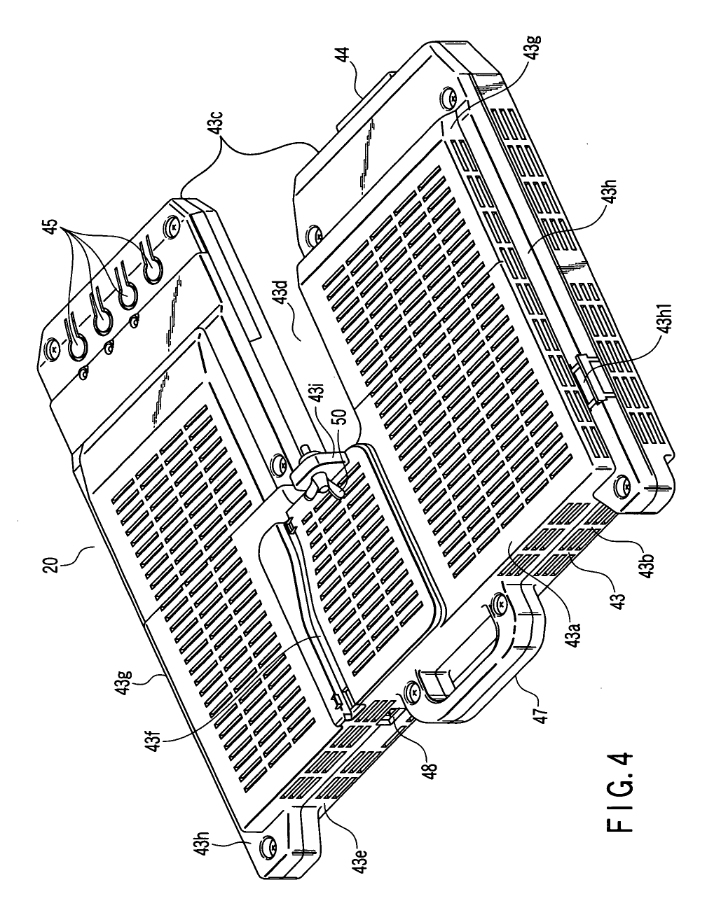

FIG. 4 is an appearance of the HDD unit 20. The HDD unit 20 has a unit case 43 which is stored in the stand 13 to almost occupy the inside of the stand 13 and which is formed in an almost thin-box-like shape. The unit case 43 is constructed by uniting an upper unit case 43a and a lower unit case 43b.

On the unit case 43, at a front face 43c, i.e., at a distal end in an insertion direction when the unit case 43 is inserted into the stand 13, a runout portion 43d obtained by paring off the unit case 43 from an almost central portion to the inside is formed. As a whole, the unit case 43 is planarly formed in an almost U shape. The runout portion 43d of the unit case 43 is formed to avoid the support columnar member 41 when the unit case 43 is inserted into the stand 13.

A connector 44 is arranged at a portion corresponding to the right side of the runout portion 43d in FIG. 4 on the distal end of the unit case 43 in the insertion direction of the unit case 43 in the stand 13. The connector 44 corresponds to the connection unit 38 shown in FIG. 2. When the unit case 43 is stored in the stand 13, the connector 44 is used to receive an electric source power and a control signal supplied from the cabinet 12.

A plurality of operation pieces 45 (four operation pieces in FIG. 2) are formed in the upper unit case 43a at a portion corresponding to the left side of the runout portion 43d in FIG. 4 on the distal end of the unit case 43 in the insertion direction of the unit case 43 in the stand 13. The operation pieces 45 are formed at positions corresponding to the operators 21 arranged on the upper plate 13b of the stand 13 when the unit case 43 is stored in the stand 13.

These operation pieces 45 are obtained by cutting the upper unit case 43a in the forms of tongues and making the cut pieces elastic. The operation pieces 45 relay operations as follows. That is, when the operators 21 are operated by pressure, the operation pieces 45 are elastically transformed inwardly by the pressure from the operators 21 to operate a switch 46 (not shown in FIG. 4) installed in the unit case 43 by pressure.

On a rear end of the unit case 43 in the insertion direction of the unit case 43 in the stand 13, i.e., on a back face 43e, a handle 47 to pull the unit case 43 from the stand 13 is arranged.

Furthermore, an i.Link connector 48 is arranged on the back face 43e of the unit case 43. The i.Link connector 48 corresponds to the i.Link connection unit 40 shown in FIG. 2, and is used to exchange video and audio signals with the cabinet 12 when the unit case 43 is stored in the stand 13.

In this case, a signal line (not shown in FIG. 4) 49 extending from the cabinet 12 side and corresponding to the line 39 shown in FIG. 2 is connected to the i.Link connector 48. Therefore, in a planar portion of the upper unit case 43a, a guide groove 43f to store the signal line 49 and to guide the signal line 49 to the i.Link connector 48 is formed.

On a pair of side faces 43g in a direction perpendicular to the insertion direction of the unit case 43 in the stand 13, i.e., the width direction, guide faces 43h serving as guides when the unit case 43 is inserted into the stand 13 are formed, respectively. The guide faces 43h are formed to face upward when the unit case 43 is inserted into the stand 13 and to be along the insertion direction.

Furthermore, on the guide faces 43h, a leaf spring 43h1 is formed near the rear end in the insertion direction of the unit case 43 in the stand 13. The leaf spring 43h1 is formed to cut the guide faces 43h in the forms of tongues and to generate an upward biasing force with reference to the guide faces 43h.

An attaching piece 43i is formed at a position corresponding to the deepest portion of the runout portion 43d on the planar portion of the upper unit case 43a. A screw 50 is configured to be inserted into the attaching piece 43i along the insertion direction of the unit case 43 in the stand 13. The screw 50 is screwed together with the support columnar member 41 in the stand 13 when the unit case 43 is stored in the stand 13 to fix the unit case 43. As the screw 50, a screw which can be rotated with a bare hand of a user without a tool such as a screw driver is used.

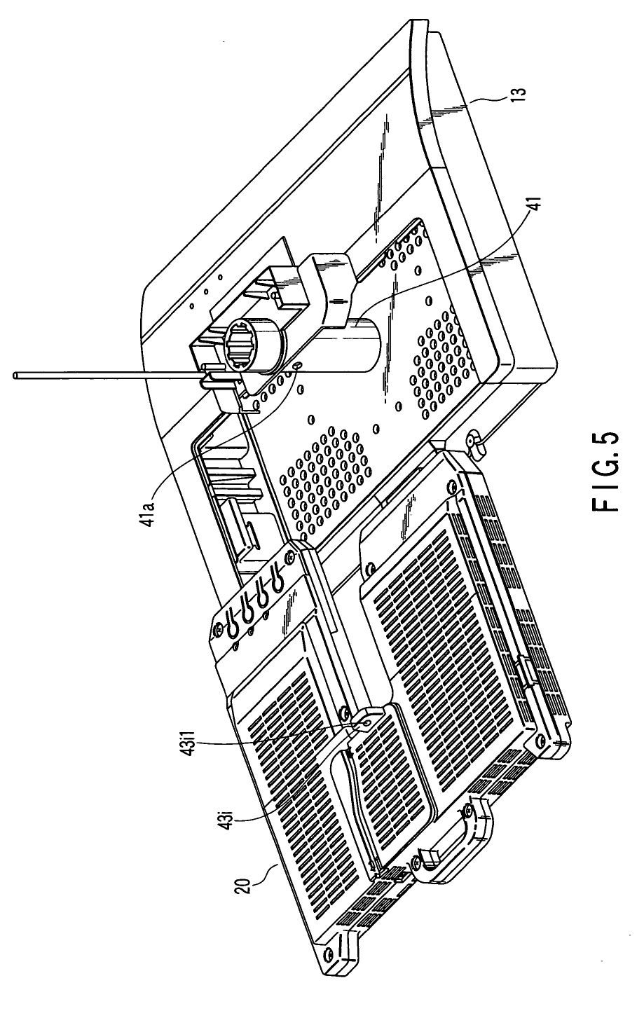

FIG. 5 shows the stand 13 when viewed from the back side. FIG. 5 is different from FIG. 3 in that the support member 19 is removed from the support columnar member 41. More specifically, a through hole 43i1 into which the screw 50 is inserted is formed in the attaching piece 43i formed on the upper unit case 43a of the unit case 43. On the support columnar member 41, a screw hole 41a with which the screw 50 is screwed together is formed at a position opposing the through hole 43i1 of the attaching piece 43i when the unit case 43 is inserted into the stand 13.

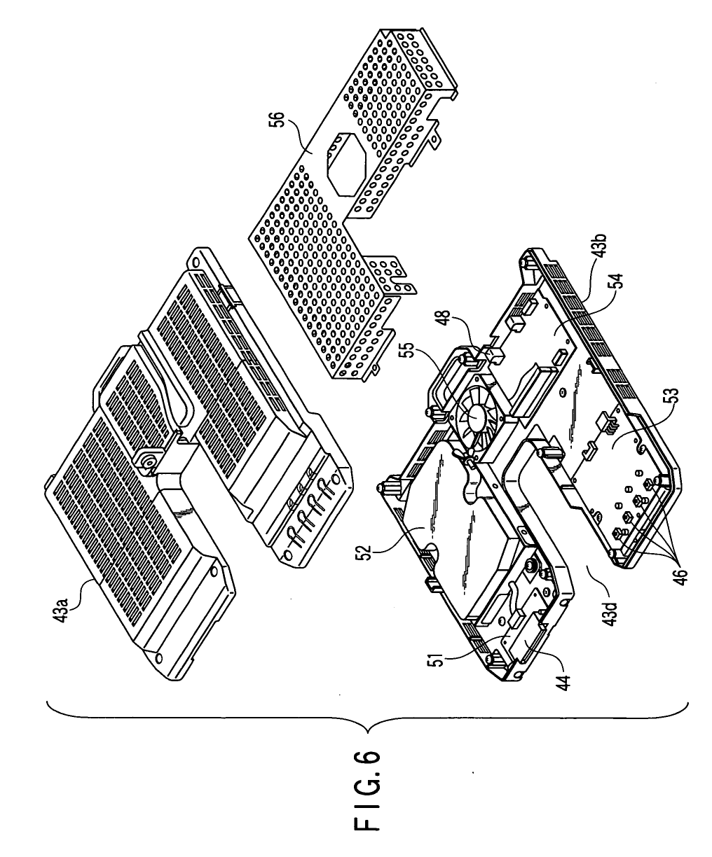

FIG. 6 shows an internal configuration of the HDD unit 20. More specifically, in the lower unit case 43b, a relay circuit board 51 connected to the connector 44 and the HDD main body 52 are stored on a side on which the connector 44 is arranged, of both the sides sandwiching the runout portion 43d.

In the lower unit case 43b, an operation power supply circuit board 53 to which the switch 46 has been connected and a control circuit board 54 to which the i.Link connector 48 has been connected are stored on a side on which the switch 46 depressed by the operation piece 45 in the upper unit case 43a is arranged, of both the sides sandwiching the runout portion 43d.

A cooling fan 55 is arranged at a center portion of the lower unit case 43b.

The HDD main body 52 and the control circuit board 54 are covered with a shield case 56 to suppress leakage of unnecessary radiation in digital high-speed processing, and the lower unit case 43b and the upper unit case 43a are united with each other to constitute the HDD unit 20.

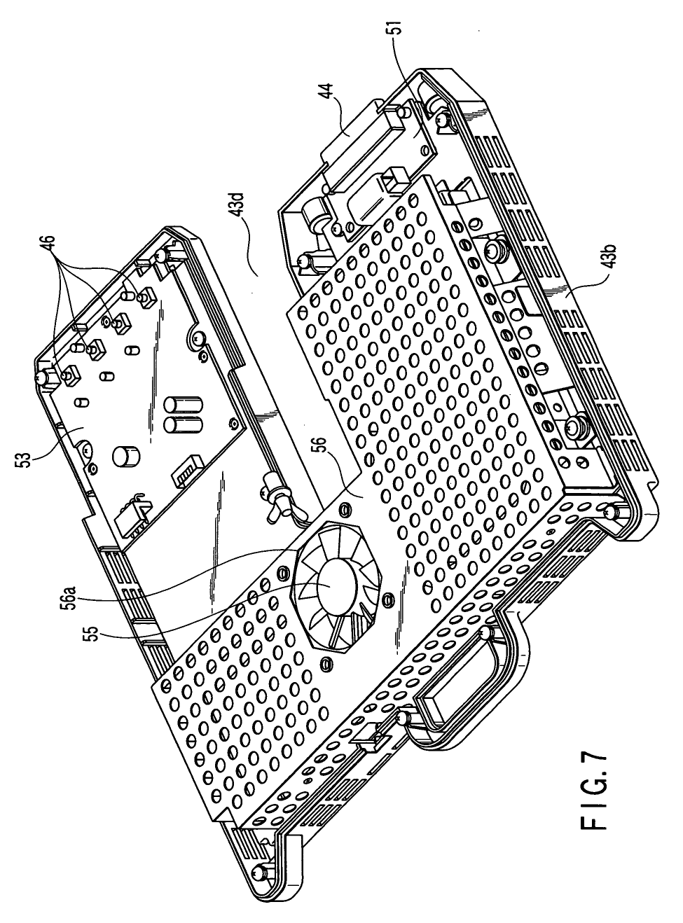

FIG. 7 shows a state in which the shield case 56 is attached to the lower unit case 43b. An opening 56a having a diameter almost equal to that of the cooling fan 55 is formed in a portion of the shield case 56 corresponding to the cooling fan 55 to take a measure for preventing an air flow from being interrupted by heat radiation.

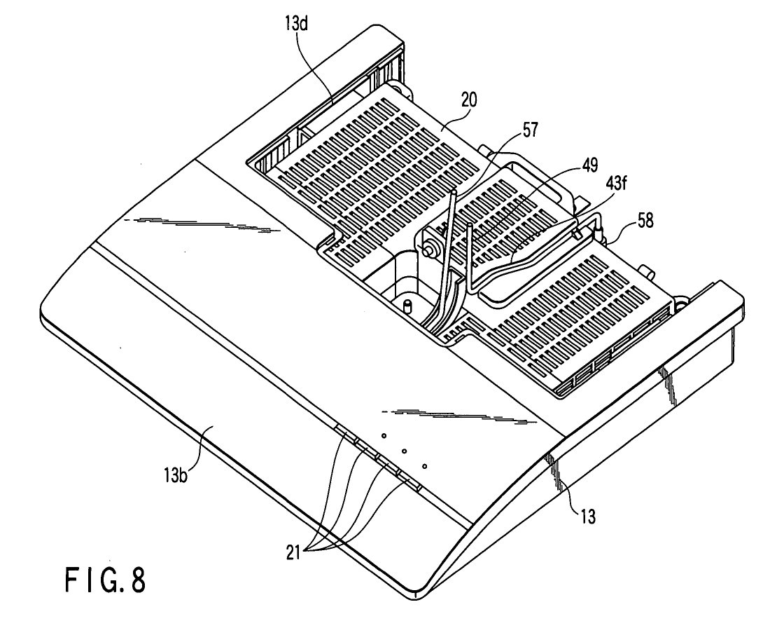

FIG. 8 shows the stand 13 in which the HDD unit 20 is stored when viewed from the front side. More specifically, the HDD unit 20 is covered with the upper plate 13b of the stand 13 in an area extending from the distal end of the HDD unit 20 in the insertion direction in the stand 13 to an almost central portion. The attaching/detaching port 13d of the stand 13 is opened or closed by a lid (not shown) to store the HDD unit 20 in the stand 13 without being exposed.

In this case, the signal line 49 and a power supply control line 57 extend from the cabinet 12 toward the inside of the storing unit 42 in order to electrically connect the cabinet 12 to the HDD unit 20 stored in the stand 13.

Of the lines, the signal line 49, as described above, corresponds to the line 39 shown in FIG. 2, and is used to exchange video and audio signals with the cabinet 12. An i.Link connector 58 (corresponding to the i.Link connection unit 40 in FIG. 2) to be connected to the i.Link connector 48 arranged on the back face 43e of the HDD unit 20 is fixed to the distal end of the signal line 49.

In a state in which the HDD unit 20 is stored in the stand 13, the signal line 49 is led in the guide groove 43f formed in the upper unit case 43a. The i.Link connector 58 fixed to the distal end of the signal line 49 is connected to the i.Link connector 48 arranged on the back face 43e of the HDD unit 20. In this manner, video and audio signals can be transmitted between the cabinet 12 and the HDD unit 20.

The power supply control line 57 corresponds to the line 37 shown in FIG. 2, and is used to supply an electric source power and a control signal from the cabinet 12 to the HDD unit 20.

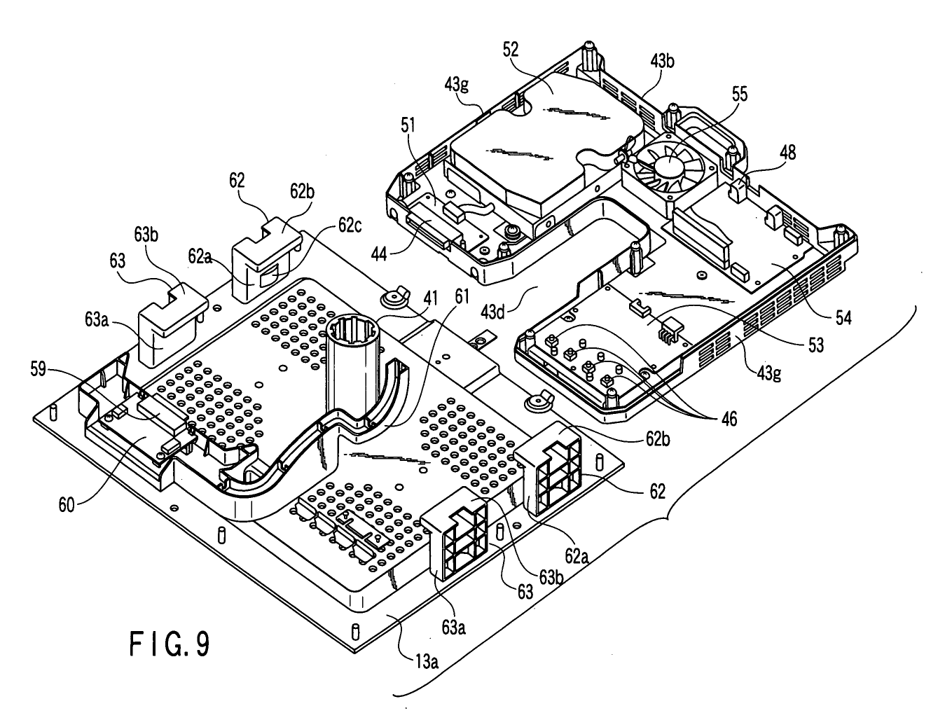

FIG. 9 shows a state in which the upper plate 13b of the stand 13 is removed. More specifically, in the stand 13, a connector 59 is arranged at a position corresponding to the connector 44 of the HDD unit 20 stored in the stand 13. The connector 59 corresponds to the connection unit 38 shown in FIG. 2. When the HDD unit 20 is stored in the stand 13, the connector 44 of the HDD unit 20 is connected to the connector 59.

The connector 59 is fixed to a relay circuit board 60 fixed to the bottom plate 13a of the stand 13. The power supply control line 57 extending from the cabinet 12 is connected to the relay circuit board 60. In this manner, an electric source power and a control signal can be supplied from the cabinet 12 to the HDD unit 20 through the power supply control line 57, the relay circuit board 60, and the connectors 59 and 44.

In this case, the arrangement position of the relay circuit board 60 in the stand 13, as can be easily supposed in FIG. 8 when viewed from a position shown in FIG. 9, is the deepest side of the area in the stand 13 covered with the upper plate 13b when viewed from the attaching/detaching port 13d. For this reason, a user cannot easily touch the relay circuit board 60 in a state in which the HDD unit 20 is removed from the stand 13.

On the bottom plate 13a of the stand 13, a protecting path 61 to guide the power supply control line 57 extending from the cabinet 12 to the relay circuit board 60 is formed. The protecting path 61 is formed in the shape of a groove which stores the power supply control line 57 and leads the power supply control line 57. The protecting path 61 protects the power supply control line 57 from being touched by the user in a state in which the HDD unit 20 is removed from the stand 13.

On the bottom plate 13a of the stand 13, two pairs of guide members 62 and 63 engaged with the one pair of side faces 43g of the HDD unit 20 and the guide faces 43h formed on the side faces 43g, respectively, are arranged along the insertion direction of the HDD unit 20.

The guide members 62 and 63 are arranged in opposition to each other to sandwich the HDD unit 20 in the width direction thereof. The guide members 62 and 63 include first guide portions 62a and 63a and second guide portions 62b and 63b. The first guide portions 62a and 63a are engaged with the side faces 43g of the HDD unit 20 to regulate the positions of the side faces 43g in the width direction. The second guide portions 62b and 63b are engaged with the guide faces 43h formed on the side faces 43g of the HDD unit 20 to regulate the positions of the guide faces 43h in the height direction.

In this case, the guide members 63 positioned on the deep side in the attaching/detaching port 13d of the stand 13 are set such that the first and second guide portions 63a and 63b are in almost tight contact with the side faces 43g and the guide faces 43h of the HDD unit 20.

In contrast to this, the guide members 62 positioned near the attaching/detaching port 13d of the stand 13 are set such that slight gaps between the first and second guide portions 62a and 62b and the side faces 43g and the guide faces 43h of the HDD unit 20.

In this manner, the HDD unit 20 can be easily inserted into the stand 13, and, in the insertion state, the connector 44 can be correctly connected to the connector 59.

In the guide member 62 positioned near the attaching/detaching port 13d of the stand 13, a leaf spring 62c which is in press contact with the side faces 43g of the HDD unit 20 is formed on the first guide portion 62a. The leaf spring 62c is obtained by cutting a part of the first guide portion 62a in the form of a tongue and giving elasticity to the cut portion. In this manner, the HDD unit 20 stored in the stand 13 can be suppressed from being unstable in the width direction.

Furthermore, in a state in which the HDD unit 20 is stored in the stand 13, the leaf spring 43h1 (see FIG. 4) formed on the guide face 43h is brought into press contact with the second guide portion 63b of the guide member 63. In this manner, the HDD unit 20 stored in the stand 13 can be suppressed from being unstable in the height direction.

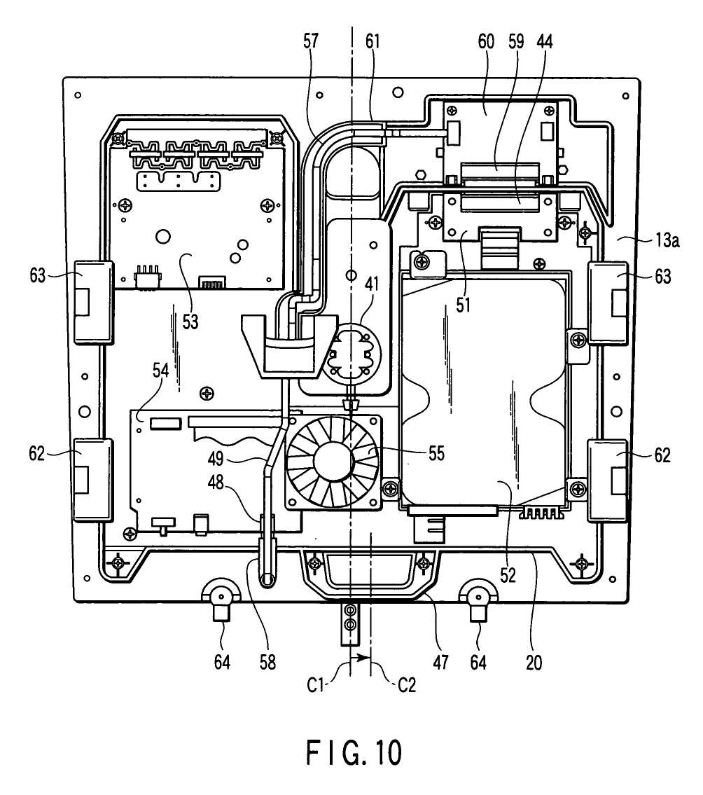

FIG. 10 shows a state in which the upper plate 13b of the stand 13 in which the HDD unit 20 is stored is removed. More specifically, it is understood that the connector 44 of the HDD unit 20 is connected to the connector 59 attached to the relay circuit board 60 in the stand 13. The power supply control line 57 which electrically connects the relay circuit board 60 to the cabinet 12 is stored in the protecting path 61 formed in the stand 13.

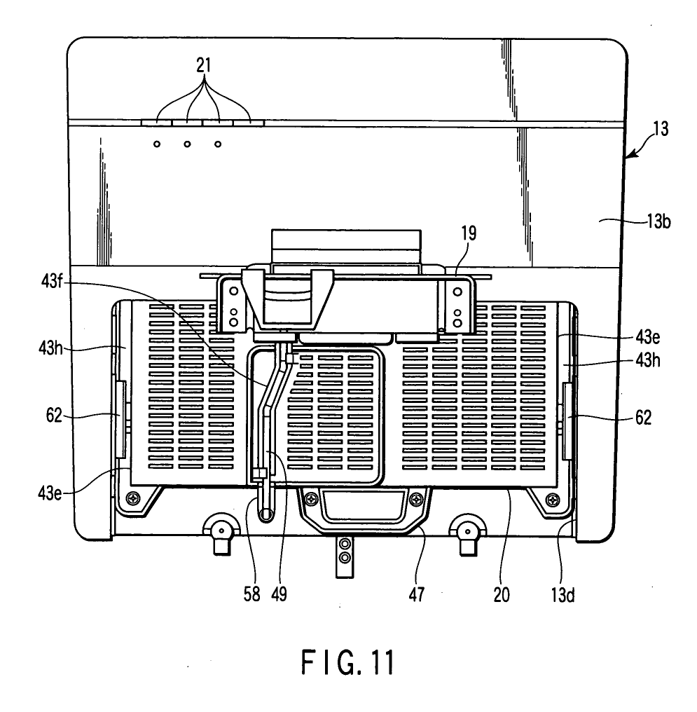

FIG. 11 shows the stand 13 in which the HDD unit 20 is stored when viewed from the upper side. More specifically, it is understood that the signal line 49 which transmits video and audio signals between the cabinet 12 and the HDD unit 20 is stored in the guide groove 43f formed in the HDD unit 20 and that the i.Link connector 58 fixed to the distal end of the signal line 49 is connected to the i.Link connector 48 arranged on the back face 43e of the HDD unit 20.

Furthermore, it is understood that the back face 43e and the guide faces 43h of the HDD unit 20 are guided by the guide member 62 in the stand 13.

In this case, the HDD unit 20 is removed from the stand 13 such that the handle 47 is drawn by a user in a state in which the HDD unit 20 is stored in the stand 13. In this case, the position of the handle 47 is considered as follows. That is, in a state in which the user presses the cabinet 12 with her/his hand to make the cabinet 12 stable, the handle 47 is held by the other hand to make it possible to remove the HDD unit 20, i.e., to make it possible to draw the HDD unit 20 with a single hand.

More specifically, as shown in FIG. 10, in the HDD unit 20 which is formed in an almost planarly U shape, a part in which the HDD main body 52, of two parts arranged in parallel to each other to sandwich the runout portion 43d, is stored is heavier than the other part. Namely, the center of gravity of the HDD unit 20 is not present on a center line C1 of the HDD unit 20 in the width direction. The center of gravity is present at a position near the part which the HDD main body 52 is stored with reference to the center line C1.

The part in which the HDD main body 52 is stored has the connector 44 connected to the connector 59 in the stand 13. For this reason, when the HDD unit 20 is drawn from the stand 13, a load to draw the connector 44 of the HDD unit 20 from the connector 59 in the stand 13 is added to the part in which the HDD main body 52 is stored.

For this reason, the handle 47 is provided to draw out the connector 44 of the HDD unit 20 from the connector 59 in the stand 13 and to draw the HDD unit 20 from the stand 13. A center line C2 of the handle 47 is set near the part in which the HDD main body 52 is stored with reference to the center line C1 of the HDD unit 20 in the width direction, thereby making it possible to easily remove the HDD unit 20 from the stand 13 with a single hand.

A pair of tip-resistant bands 64 set in consideration of the center of gravity of the television broadcasting receiver 11 as a whole on the back side of the bottom plate 13a of the stand 13. In this case, the handle 47 is preferably set such that the center line C2 is present between the pair of tip-resistant bands 64.

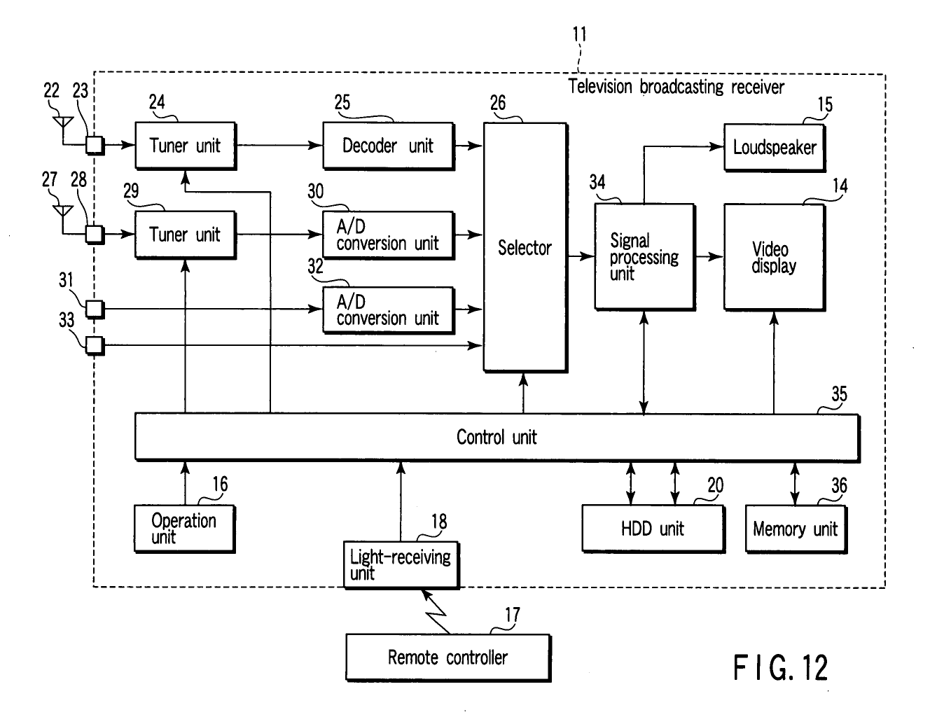

In FIG. 2, as the signal processing system of the television broadcasting receiver 11, the cabinet 12 and the stand 13 obtained by dividing the signal processing system are shown. However, as the signal processing system, the cabinet 12 and the stand 13 need not be independently shown. As shown in FIG. 12, the signal processing system can be equivalently shown such that the television broadcasting receiver 11 includes the HDD unit 20 therein.

According to the embodiment described above, the HDD unit 20, i.e., the HDD main body 52 is built in the stand 13 to support the cabinet 12 including the video display unit 14 of the television broadcasting receiver 11. Consequently, the HDD main body 52 having a large recording capacity can be stored in the stand 13 without increasing the thickness of the cabinet 12.

The HDD main body 52 is stored in the stand 13 to make it difficult that unnecessary radiation in digital high-speed processing in the HDD main body 52 reaches the various signal processing systems in the cabinet 12, so that reproduction of video and audio signals is prevented from being adversely affected. Furthermore, the HDD main body 52 is stored in the stand 13 to prevent the various signal processing systems in the cabinet 12 from being adversely affected by heat generated by the HDD main body 52.

In this case, the HDD main body 52 is stored in the unit case 43 and unitized as the HDD unit 20, can be attached to or detached from the stand 13, and can be easily exchanged by a user. For this reason, serviceability in failure of the HDD main body 52 can be improved. The HDD main body 52 is unitized such that the HDD main body 52 is prevented from being touched by the user. For this reason, the television broadcasting receiver 11 is practical with respect to safety.

In this case, the HDD unit 20 is formed in an almost planarly U shape to avoid the support columnar member 41 arranged in the stand 13. The guide faces 43h are formed on the side faces 43g of the HDD unit 20, the two pairs of guide members 62 and 63 engaged with the side faces 43g and the guide faces 43h of the HDD unit 20 in the stand 13 are arranged to make it possible to easily attach or detach the HDD unit 20 to/from the stand 13.

In particular, the guide members 63 positioned on the deep side of the stand 13 with reference to the attaching/detaching port 13d are set to be in almost tight contact with the side faces 43g and the guide faces 43h of the HDD unit 20. The guide members 62 positioned near the attaching/detaching port 13d of the stand 13 are set to have slight gaps between the guide portions 62 and the side faces 43g and the guide faces 43h of the HDD unit 20. For this reason, the HDD unit 20 can be easily inserted into the stand 13, and, in the insertion state, the connector 44 can be correctly connected to the connector 59.

The leaf spring 62c formed on the guide members 62 and the leaf spring 43h1 formed on the guide faces 43h of the HDD unit 20 can stably hold the HDD unit 20 stored in the stand 13.

Further, since the cooling fan 55 is arranged in the HDD unit 20, heat can be efficiently radiated from the HDD main body 52. In particular, since the cooling fan 55 is arranged at the center portion of the HDD unit 20 formed in a U shape, heat generated by both the parts which sandwich the runout portion 43d can be efficiently radiated.

The HDD main body 52 and the control circuit board 54 in the HDD unit 20 are covered with the shield case 56 to make it possible to further suppress leakage of unnecessary radiation in digital high-speed processing.

Furthermore, a power supply power supplied to the HDD unit 20 stored in the stand 13 is supplied from the cabinet 12 serving as a main body of the television broadcasting receiver 11.

In this case, the power supply control line 57 which supplies an electric source power and a control signal to the HDD unit 20 is stored in the protecting path 61 formed in the stand 13 and led, so that the power supply control line 57 is protected from being touched by a user in a state in which the HDD unit 20 is removed from the stand 13.

Since the relay circuit board 60 to which the power supply control line 57 is connected is arranged on the deepest side in the stand 13 with reference to the attaching/detaching port 13d, the relay circuit board 60 is prevented from being touched by a user in a state in which the HDD unit 20 is removed from the stand 13.

Moreover, the operators 21 for controlling the HDD unit 20 are arranged on the stand 13, and the operation pieces 45 are formed at positions corresponding to the operators 21 in a state in which the HDD unit 20 is stored in the stand 13, so that operation force of the operators 21 is transmitted to the switch 46 in the HDD unit 20 through the operation pieces 45. In this manner, the switch 46 built in the HDD unit 20 which can be attached to or detached from the stand 13 can be operated from the outside.

The switch 46 is conveniently arranged on the right of the stand 13 when the stand 13 is viewed from the front side because the switch 46 can be operated by a user with her/his right hand. For this reason, in the HDD unit 20, the switch 46 must be arranged at the distal end of a part corresponding to the operator 21 of the two parts opposed to each other through the runout portion 43d in the insertion direction.

In this manner, in order to satisfy a condition in which, in the stand 13, the relay circuit board 60 is arranged on the deepest side with reference to the attaching/detaching port 13d to prevent the relay circuit board 60 from being easily touched by a user, the connector 44 of the HDD unit 20 connected to the connector 59 of the relay circuit board 60 is arranged at the distal end of the opposite part of the part in which the switch 46 is arranged of the two parts opposed to each other through the runout portion 43d in the insertion direction.

The HDD unit 20 is fixed in the stand 13 by the screw 50 which can be rotated by a user with her/his bare hand without using a tool or the like to facilitate an exchange operation by the user.

Further, transmission of video and audio signals between the HDD unit 20 stored in the stand 13 and the cabinet 12 serving as the main body of the television broadcasting receiver 11 is performed by i.Link connection.

In this case, the signal line 49 which connects the cabinet 12 to the HDD unit 20 is stored in the guide groove 43f formed in the HDD unit 20 and led to the back face 43e of the HDD unit 20. The i.Link connector 58 fixed to the distal end of the signal line 49 is connected to the i.Link connector 48 arranged on the back face 43e of the HDD unit 20.

In this manner, an operation of connecting the i.Link connector 58 to the i.Link connector 48 of the HDD unit 20 by a user is facilitated. In addition, the signal line 49 is stored in the guide groove 43f of the HDD unit 20 to protect the signal line 49, and the height of the stand 13 can be suppressed.

Furthermore, the center of the handle 47 to draw the HDD unit 20 from the stand 13 is set near the part in which the HDD main body 52 is stored with reference to the center line C1 of the HDD unit 20 in the width direction, so that a user can easily remove the HDD unit 20 from the stand 13 with her/his single hand.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
an apparatus main body having a receiving unit configured to receive a video signal, a signal processing unit configured to perform predetermined signal processing to the video signal received by the receiving unit, and a video display unit configured to display the video signal subjected to the predetermined signal processing by the signal processing unit;
an HDD unit configured to incorporate an HDD therein; and
a stand which is placed on a predetermined base and supports the apparatus main body so as to upright stand a video display screen of the video display unit, the stand having a storing unit which attachably/detachably stores the HDD unit in the stand, and being configured to enable to transmit a video signal between the HDD and the signal processing unit in a state in which the HDD unit is stored in the storing unit.

2. A video signal processing apparatus according to claim 1, further comprising
a connection unit which electrically connects the HDD unit to the apparatus main body when the HDD unit is inserted into the storing unit.

3. A video signal processing apparatus according to claim 1, further comprising
a guide portion to attach/detach the HDD unit to/from the storing unit.

4. A video signal processing apparatus according to claim 1, further comprising
an operation unit to control the HDD unit stored in the storing unit, the operation unit being formed on the stand.

5. A video signal processing apparatus according to claim 1, further comprising
a shield case which covers the HDD and which is built in the HDD unit.

6. A video signal processing apparatus according to claim 1, further comprising
a control circuit board for the HDD which is built in the HDD unit.

7. A video signal processing apparatus according to claim 1, further comprising
a fan which is built in the HDD unit and which cools the HDD.

8. A video signal processing apparatus according to claim 1, further comprising
one support columnar member which is perpendicularly protruded at a center of the storing unit of the stand formed in an almost thin-box-like shape to support the apparatus main body, wherein
the HDD unit has such a shape that the HDD unit is stored in the storing unit to avoid the support columnar member.

9. A television broadcasting receiver comprising:
an apparatus main body having a receiving unit configured to receive a television broadcasting signal, a signal processing unit configured to perform predetermined signal processing to the television broadcasting signal received by the receiving unit to recover a video signal, and a video display unit configured to display the video signal recovered by the signal processing unit;
an HDD unit configured to incorporate an HDD therein; and
a stand which is placed on a predetermined base and supports the apparatus main body so as to upright stand a video display screen of the video display unit, the stand having a storing unit which attachably/detachably stores the HDD unit in the stand, and being configured to enable to transmit a video signal between the HDD and the signal processing unit in a state in which the HDD unit is stored in the storing unit.

10. A television broadcasting receiver according to claim 9, further comprising
an operation unit to control the HDD unit stored in the storing unit, the operation unit being formed on the stand.
